(19) United States
(12) Patent Application Publication
(10) Pub. No.: US 2009/0116674 A1
(43) Pub. Date: May 7, 2009

(54) Microphone

(76) Inventors: Chun-Nan Chen, Taichung (TW); I-Ming Lin, Taichung (TW)

Correspondence Address: Muncy, Geissler, Olds & Lowe, PLLC, P.O. BOX 1364, FAIRFAX, VA, 22038-1364, US

(21) Appl. No.: 11/934,828

(22) Filed: Nov. 5, 2007

(51) Int. Cl. H04R 9/08

(52) U.S. Cl. 381/355

(57) ABSTRACT

A microphone includes a casing. A circuit board is mounted in the casing. The circuit board includes an audio conversion unit and a switch mounted thereon. Activation of the switch controls on/off the audio conversion unit. A mounting member is securely mounted in the casing. The mounting member includes a plurality of holes and a plurality of returning members monolithically formed thereon. A lid includes a plurality of hooks engaged with the respective holes of the mounting member. The lid can be moved for activation of the switch and can be urged to its original position by the plurality of returning members.

### BACKGROUND OF THE INVENTION

1. Field of the Invention

The present invention relates to a microphone, and more particularly, to a hand-free microphone.

2. Description of the Related Art

Referring to FIG. 7, a prior microphone includes a casing 1 which defines an open space for receiving a mounting member 2, a returning member 4, and a circuit board 5 with a switch 6. The microphone also includes a lid 3 which covers the open space thereof. The lid 3 includes a projection 9 which is adapted to activate the switch 6. The lid 3 provides a user an easy activation of the microphone. The microphone also has two strain relief bushings 7 and two wire clips 8 provided for the wires (not shown). Furthermore, the returning member 4, the strain relief bushings 7, and the wire clips 8 are made of metal. However, there are some problems associated with this microphone. One such problem is that the microphone is inherently relatively thick in order to house the returning member 4 and allow the user to apply a force to sufficiently deform the returning member 4 between the mounting member 2 and the lid 3. Another problem is that the insensitive activation of the switch 6 often happens when the user press the lid 3 at the corner. Yet another problem is that the metallic returning member 4, strain relief bushings and wire clips 8 can cause electrostatic discharge for the microphone.

The present invention is, therefore, intended to obviate or at least alleviate the problems encountered in the prior art.

### SUMMARY OF THE INVENTION

The present invention overcomes the disadvantages of the prior microphone by providing a microphone with a plurality of returning members, which can help reduce the overall thickness of the microphone and make it as light as possible.

The microphone comprises a casing in which a circuit board having four corners is mounted. The circuit board includes an audio conversion unit and a switch mounted thereon. Activation of the switch controls on/off the audio conversion unit. A mounting member is mounted in the casing and includes a plurality of holes formed at two respective distal ends and a plurality of monolithically formed returning members. The microphone also includes a lid mounted to the casing. The lid includes a plurality of hooks engaged with the respective holes of the mounting member. The lid is moveable relative to the mounting member in a restrained manner between a position for pressing against the switch and a position for disengaging with the switch. A projection is extended from the lid. The projection has a first portion extending diagonally toward a pair of corners of the lid and a second portion extending diagonally toward another pair of corners. When the lid is pressed, the switch is activated by the projection and hence turns on/off the audio conversion unit, and when the pressing force is withdrawn, the returning members are returned to its original position and the lid is returned to its initial non-activating position by the returning members. It is to be noted that another pressing of the lid will turn the audio conversion unit off.

It is one aspect of the invention that the mounting member includes a plurality of monolithically formed returning members. The returning members are biasable between a first position and a second position in correspondence with pressing of the lid. Furthermore, the returning members help reduce the overall thickness of the microphone and reduce the number of components used in the microphone.

Other objectives, advantages, and novel features of the invention will become more apparent from the following detailed description when taken in conjunction with the accompanying drawings.

### BRIEF DESCRIPTION OF THE DRAWINGS

For the present disclosure to be easily understood and readily practiced, the present disclosure will now be described for the purpose of illustration not limitation, in conjunction with the following figures, wherein;

FIG. 1 is a perspective view of a microphone in accordance with the present invention.

FIG. 2 is exploded view of the microphone shown in FIG. 1.

FIG. 3 is a cross-sectional view taken along line 3-3 of FIG. 1.

FIG. 4 is a cross-sectional view taken along line 4-4 of FIG. 1.

FIG. 5 is a cross-sectional view taken along line 5-5 of FIG. 1.

FIG. 6 is a cross-sectional view of the microphone similar to that of FIG. 5, but with a lid of this invention being pressed in accordance with the direction of the arrow.

FIG. 7 is an exploded view of a conventional microphone.

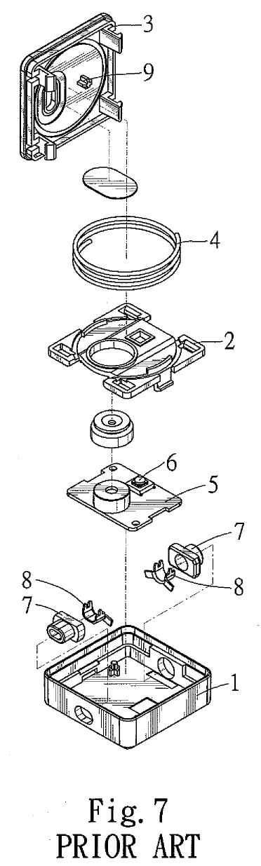

### DETAILED DESCRIPTION OF THE PREFERRED EMBODIMENT

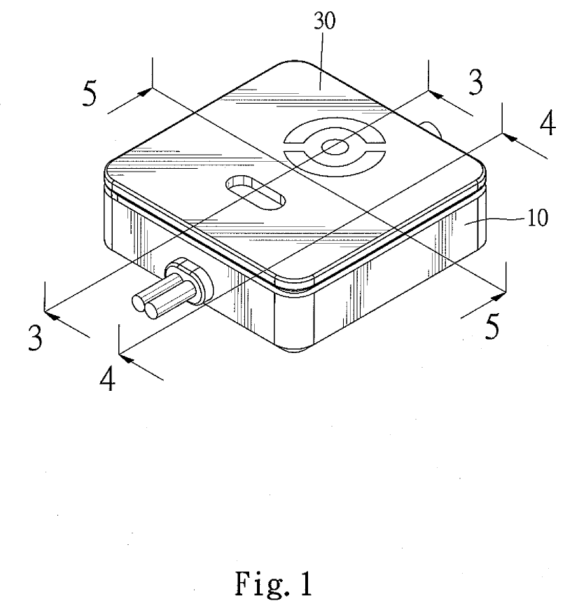

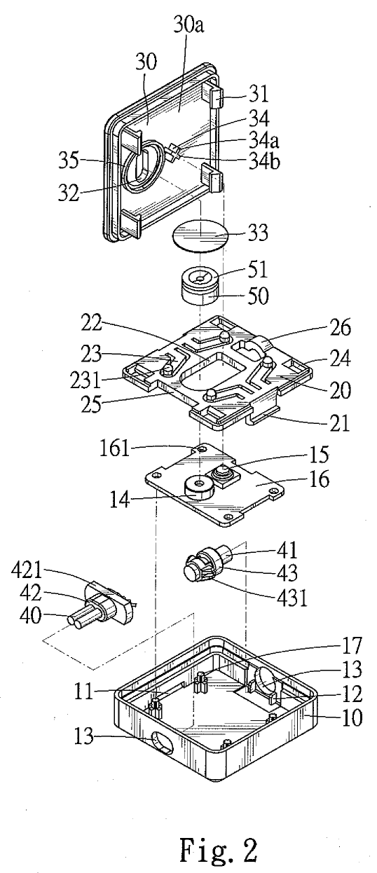

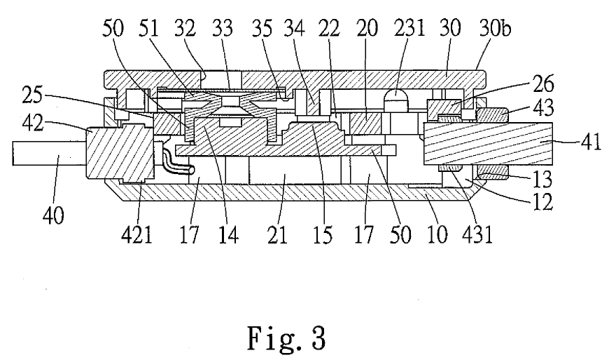

Referring to FIGS. 1 through 3, a microphone in accordance with the present invention includes a casing 10 with an open side and a lid 30 that covers the open side of the casing 10. The casing 10 is square in section, thus it defines four corners and four ends.

On the inner periphery of the casing 10, there are two locking slots 11 formed thereof and disposed at two distal ends respectively. Two wire holes 13 are formed at the remaining ends of the casing 10 respectively, with one wire hole 13 provided for receiving a first wire 40 and another provided for receiving a second wire 41. A first strain relief member 42 and a second strain relief member 43 are provided for the first and second wires 40, 41 respectively. The first strain relief member 42 has a retaining portion 421 which prevents the first strain relief member 42 from being pulled off the casing 10. The second strain relief member 43 has a retaining portion 431 which prevents the second strain relief member 43 from being pulled off the casing 10. Furthermore, the first and second strain relief members 42, 43 are made of material which prevents the occurrence of electrostatic discharge. The casing 10 also has two protrusions 12 formed thereof for engaging with the retaining portion 431 of the second strain relief member 43. The second strain relief member 43 can thus be restrained from rotating relative to the casing 10. It will be appreciated that the first strain relief member 42 is provided for the second wire 41, and the second strain relief member is provided for the first wire 40.

The casing 10 also has a plurality of engaging portions 17 formed therein for securely engaging a circuit board 16. More specifically, the circuit board 16 includes a plurality of bores 161 adapted to receive the engaging portions 17 respectively. The circuit board 16 is electrically connected with the first wire 40 and the second wire 41.

An audio conversion unit 14 and a switch 15 are mounted close to the center of the circuit board 16, and the switch 15 is electrically connected with the audio conversion unit 14 such that activation of the switch 15 controls on/off the audio conversion unit 14. It will be appreciated that connections between the circuit board 16 and the first and second wires 41, 42, and connection between the audio conversion unit 14 and the switch 15 are within the skill of the art.

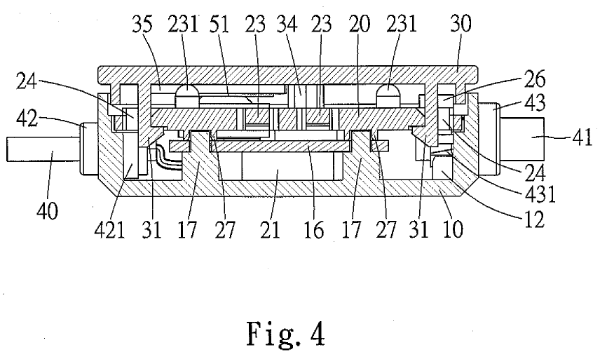

Referring to FIGS. 4 through 6, a mounting member 20 is mounted above the circuit board 16. The mounting member 20 is substantially square in section and includes two anchoring portions 21 which extend perpendicularly therefrom for engaging in the respective locking slots 11. Thus, the mounting member 20 is securely fixed with the casing 10. The mounting member 20 also includes a plurality of recesses 27 for receiving the plurality of engaging portions 17 respectively. As such, the circuit board 16 mounted securely between the mounting member 20 and the protrusions 17. Furthermore, the mounting member 20 includes a cutout 22 formed thereof for allowing the audio conversion unit 14 and the switch 15 to pass through the mounting member 20. It will be appreciated that the audio conversion unit 14 and the switch 15 may be located outside, completely received in, or extended beyond the cutout 22. In addition, the mounting member 20 includes two holes 24 at two respective distal ends, an indentation 25 with which the first retaining member 42 engages, and a pressing member 26 which holds the second strain relief member 43 and thereby providing a friction for preventing rotation of the second strain relief member 43 relative to the casing 10. Preferably, the pressing member 26 is arcuate.

A plurality of returning members 23 are monolithically formed on the mounting member 20. The returning members 23 are biasable between a first position and a second position and are arranged in pairs. Furthermore, each returning member 23 is disposed within the periphery of the mounting member 20 and includes a protuberance 231 formed thereon. The protuberance 231 extends in the direction opposite the extending direction of the anchoring portion 21.

The lid 30 is square in section and includes a plurality of hooks 31 engaged within the holes 24 defined by the mounting member 20 respectively. Thus, the lid 30 is fixed to the mounting member 20. The lid 30 also defines an inner face 30a against which the protuberance 231 abut and an outer face 30b which allows a user to press during activation of the microphone.

A projection 34 is formed on the inner face 30a of the lid 30. The projection 34 includes a first portion 34a extending diagonally toward a pair of corners of the lid 30 and a second portion 34b extending diagonally toward another pair of corners. The first and the second portions 34a, 34b are intercrossed. When the outer face 30b of the lid 30 is pressed, the switch 15 is activated by the projection 34 and hence turns on/off the audio conversion unit 14.

A sound hole 32 is also formed on the inner face 30a and disposed at a position corresponding to the audio conversion unit 14 to thereby allowing the audio conversion unit 14 to receive sound waves via the sound hole 32. The sound hole 32 has a ridge 35 formed about its perimeter.

An air-permeable dustproof sheet 33 is disposed on the inner face 30a of the lid 30, and, the air-permeable dustproof sheet 33 is positioned in correspondence with the sound hole 32 such that the ridge 35 circumscribes the periphery of the air-permeable dustproof sheet 33.

A resilient member 50 is mounted between the audio conversion unit 14 and the inner face 30a of lid 30 for assisting biasing action of the lid 30. The resilient member 50 includes a first end defining a compressible portion 51 which abuts against the lid 30 and a second end which engages with the audio conversion unit 14. The air-permeable dustproof sheet 33 is sandwiched between the lid 30 and the resilient member 50.

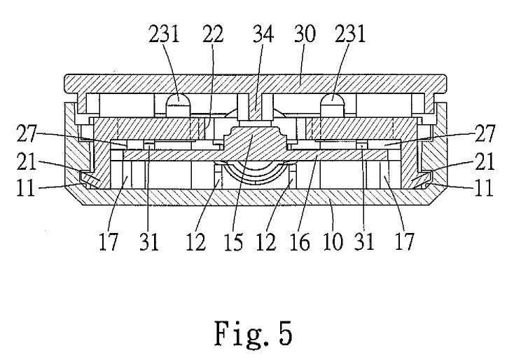

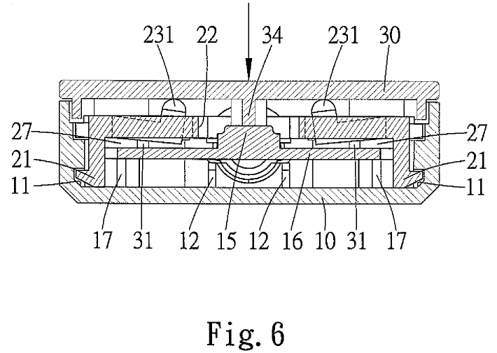

Still referring to FIG. 6, when the audio conversion unit 14 is to be activated for receiving sound waves, the outer face 30b of the lid 30 is pressed and hence the returning members 23 and the resilient member 50 are compressed, the switch 15 is thereafter activated and hence turns on/off the audio conversion unit 14. Since the switch 15 is disposed close to the center of the circuit board 16 and the projection 34 which activates the switch 15 has the first portion 34a extending diagonally toward a pair of corners of the lid 30 and the second portion 34b extending diagonally toward another pair of corners such that they are intercrossed at the center of the lid 30. The force applied to the lid 30 is equally distributed. Accordingly, the switch 15 is more sensitively activated by the lid 30. After the pressing force is withdrawn, the returning members 23 are returned to its original position so that the lid 30 is returned to its initial non-activating position by the returning members 23, as illustrated in FIG. 5. It will be appreciated that another pressing of the lid 30 will turn the audio conversion unit off, which is within the skill of the art.

In view of the foregoing, one advantage of the microphone in accordance with the present invention is the provision of the mounting member 20 with a plurality of monolithically formed returning members 23. The returning members 23 are biasable between a first position and a second position by pressing of the lid 30. Furthermore, the returning members 23 help reduce the overall thickness of the microphone and help decrease the number of components used in the microphone.

Another advantage is that the provision of the centrally positioned switch 15 and projection 34. Accordingly, the force applied to the lid 30 for activation of the switch 15 is equally distributed.

Yet another advantage of the invention is the provision of the first and strain relief member 42, 43 having respective retaining portions 421, 431 that prevent pulling and dragging of the wires 40, 41 from the circuit board 16.

While the specific embodiments have been illustrated and described, numerous modifications come to mind without significantly departing from the spirit of invention and the scope of invention is only limited by the scope of accompanying claims.

What is claimed is:

1. A microphone comprising:
a casing having an open side;
a circuit board mounted in the casing, comprising an audio conversion unit mounted on the circuit board, and a switch mounted on the circuit board and electrically connected to the audio conversion unit such that activation of the switch controls on/off the audio conversion unit;
a mounting member securely mounted in the casing, having a plurality of holes formed at two respective distal ends and a plurality of returning members monolithically formed thereon; and
a lid having a plurality of hooks engaged with said respective holes;
wherein said lid is adapted to be moved for activation of the switch and said lid can be biasably urged to its original position by said plurality of returning members.

2. The microphone as claimed in claim 1, wherein said returning member comprises a protuberance that can be pressed by said lid, and said lid can be biasably urged to its original position by said protuberance.

3. The microphone as claimed in claim 1, wherein said lid comprises a centrally positioned projection for activating said switch, without imparting a component force on said switch.

4. The microphone as claimed in claim 3, wherein said projection comprises a first portion extending diagonally, and a second portion extending diagonally intercrossing said first portion.

5. The microphone as claimed in claim 1, wherein said casing comprises two wire holes for receiving a first and a second wire respectively, with said first and second wires being adapted to connect to said circuit board.

6. The microphone as claimed in claim 5, wherein said first and second wires have a first and a second strain relief member respectively, said first and second strain relief members have a first and second retaining portion respectively for preventing detachment from said casing.

7. The microphone as claimed in claim 1, wherein said mounting member comprises a cutout for allowing said switch and audio conversion unit to be located outside, completely received in, or extended beyond.

8. The microphone as claimed in claim 1, wherein said casing comprises a plurality of engaging portions for attaching said circuit board, said circuit board has a plurality of bores for receiving said plurality of engaging portions respectively.

9. The microphone as claimed in claim 8, wherein said mounting member comprises a plurality of recesses for receiving said plurality of engaging portions respectively, allowing said mounting member to be stably mounted in said casing.

10. The microphone as claimed in claim 1, wherein said lid comprises a sound hole disposed corresponding to said audio conversion unit, allowing said audio conversion unit to receive sound waves through said sound hole.

11. The microphone as claimed in claim 10, wherein said lid comprises a ridge formed about said sound hole and an air-permeable dustproof being received in said ridge.

12. The microphone as claimed in claim 1, further comprising a resilient member mounted between said audio conversion unit and lid, for assisting biasing action of the lid.

13. The microphone as claimed in claim 9, wherein said casing comprises at least one locking slot for allowing said mounting member to be engaged in.

14. The microphone as claimed in claim 13, wherein said mounting member comprises at least one anchoring portion extending therefrom, for being received in said at least one locking slot respectively.
